(19) United States
(12) Patent Application Publication
(10) Pub. No.: US 2023/0204377 A1
(43) Pub. Date: Jun. 29, 2023

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventor: Kee Hoon Choi, Suwon-si (KR)

(73) Assignees: HYUNDAI MOTOR COMPANY, Seoul (KR); KIA CORPORATION, Seoul (KR)

(21) Appl. No.: 18/078,642

(22) Filed: Dec. 9, 2022

(30) Foreign Application Priority Data
Dec. 29, 2021 (KR) 10-2021-0191119

(51) Int. Cl. G01C 21/00; G06V 20/56; B60W 30/18; B60W 60/00

(52) U.S. Cl. CPC G01C 21/3815; B60W 30/18163; B60W 60/001; G06V 20/588; B60W 2420/42

(57) ABSTRACT

Disclosed is a method of controlling a vehicle. The method includes: obtaining information on a first lane of a currently driving road from a foreground image of the vehicle, obtaining information on a second lane of the currently driving road from map data of a navigation, and updating the information on the second lane of the map data by sharing the information on the first lane obtained from the foreground image of the vehicle with the navigation.

### CROSS-REFERENCE TO RELATED APPLICATION(S)

This application claims the benefit of and priority to Korean Patent Application No. 10-2021-0191119, filed on Dec. 29, 2021, the entire contents of which are incorporated herein by reference.

### TECHNICAL FIELD

The present disclosure relates to a vehicle, and to a route guidance of a vehicle using a navigation system.

### BACKGROUND

The statements in this section merely provide background information related to the present disclosure and may not constitute prior art.

In general, a navigation system guides a route to a set destination using map data and current location information of a vehicle. To this end, the navigation system receives map data from a map service provider and updates it. Furthermore, the navigation system displays a current location of the vehicle on a map by receiving Global Positioning System (GPS) data (coordinate values) for the current location of the vehicle through communication with GPS satellites.

However, since a navigation system for a vehicle uses civilian GPS data, which is relatively less precise than military GPS data, it is not possible to identify exactly which lane of a road the vehicle is driving on. Furthermore, if map update is not performed correctly, the actual number of lanes on a road on which the vehicle is driving may not match the number of lanes on map data.

### SUMMARY

An aspect of the present disclosure is to accurately obtain lane information of a road on which a vehicle is driving and reflect the lane information in map data of a navigation system so that accurate road information may be guided in a navigation system.

Additional aspects of the present disclosure is set forth in part in the description which follows and, in part, should be obvious from the description, or may be learned by practice of the disclosure.

In an aspect of the present disclosure, a method of controlling a vehicle includes: obtaining information on a first lane of a currently driving road from a foreground image of the vehicle, obtaining information on a second lane of the currently driving road from map data of a navigation, and updating the information on the second lane of the map data by sharing the information on the first lane obtained from the foreground image of the vehicle with the navigation.

The information on the first lane may include a total number of lanes on the currently driving road, information on a lane on which the vehicle is driving, and lane change information of the vehicle.

The information on the second lane may include a total number of lanes on the currently driving road and information on a lane on which the vehicle is driving.

Updating the information on the second lane may further include reflecting driving lane change information of the information on the first lane in addition to a total number of lanes on the currently driving road and information on the lane on which the vehicle is driving.

The method may further include, in response to that the vehicle enters or exits a new road from the currently driving road, initializing the information on the first lane and the information on the second lane by reflecting road information of the new road.

In accordance with another aspect of the disclosure, a vehicle includes a camera provided to photograph a foreground image of the vehicle, a navigation provided for guiding a route to a destination, and a controller configured to obtain information on a first lane of a currently driving road from the foreground image of the vehicle photographed by the camera, obtain information on a second lane of the currently driving road from map data of the navigation, and update the information on the second lane of the map data by sharing the information on the first lane obtained from the foreground image of the vehicle with the navigation.

The information on the first lane may include a total number of lanes on the currently driving road, information on a lane on which the vehicle is driving, and lane change information of the vehicle.

The information on the second lane may include a total number of lanes on the currently driving road and information on a lane on which the vehicle is driving.

The update of the information on the second lane may be updated by further reflecting driving lane change information of the information on the first lane in addition to a total number of lanes on the currently driving road and information on the lane on which the vehicle is driving.

The controller may be further configured to initialize the information on the first lane and the information on the second lane by reflecting road information of a new road in response to that the vehicle enters or exits the new road from the currently driving road.

In another aspect of the disclosure, a method of controlling a vehicle includes: obtaining, by a controller, from a foreground image of the vehicle, information on a first lane including: a total number of lanes on a currently driving road, information on a lane on which the vehicle is driving, and lane change information of the vehicle; obtaining, by the controller, information on a second lane including the total number of lanes on the currently driving road and information on the lane on which the vehicle is driving from map data of a navigation; updating, by the controller, the information on the second lane of the map data by sharing the information on the first lane obtained from the foreground image of the vehicle with the navigation; and initializing, by the controller, the information on the first lane and the information on the second lane by reflecting road information of a new road in response to that the vehicle enters or exits the new road from the currently driving road.

Updating the information on the second lane may further include reflecting driving lane change information of the information on the first lane in addition to a total number of lanes on the currently driving road and information on the lane on which the vehicle is driving.

In accordance with another aspect of the disclosure, a vehicle includes a camera provided to capture a foreground image of the vehicle, a navigation provided for guiding a route to a destination, and a controller configured to obtain information on a first lane including: a total number of lanes on a currently driving road, information on a lane on which the vehicle is driving, and lane change information of the vehicle, from the foreground image of the vehicle captured by the camera, obtain information on a second lane including the total number of lanes on the currently driving road and information on the lane on which the vehicle is driving from map data of the navigation, update the information on the second lane of the map data by sharing the information on the first lane obtained from the foreground image of the vehicle with the navigation, and initialize the information on the first lane and the information on the second lane based on road information of a new road in response to that the vehicle enters or exits the new road from the currently driving road.

The update of the information on the second lane may be updated by further reflecting driving lane change information of the information on the first lane in addition to a total number of lanes on the currently driving road and information on the lane on which the vehicle is driving.

### BRIEF DESCRIPTION OF THE DRAWINGS

These and/or other aspects of the disclosure should become apparent and more readily appreciated from the following description of the embodiments, taken in conjunction with the accompanying drawings of which:

FIG. 1 is a view illustrating a control system of a vehicle according to an embodiment of the present disclosure;

FIG. 2 is a view illustrating a foreground image of a vehicle captured using a front camera of the vehicle according to an embodiment of the present disclosure;

FIG. 3 is a view illustrating a shape of a road having an entrance and an exit; and

FIG. 4 is a flowchart illustrating a method of controlling the vehicle according to an embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Reference is now made in detail to the embodiments of the disclosure, examples of which are illustrated in the accompanying drawings. This specification does not describe all elements of the disclosed embodiments and detailed descriptions of what is well known in the art or redundant descriptions on substantially the same configurations have been omitted. The terms ‘part’, ‘module’, ‘member’, ‘block’ and the like as used in the specification may be implemented in software or hardware. Further, a plurality of ‘part’, ‘module’, ‘member’, ‘block’ and the like may be embodied as one component. It is also possible that one ‘part’, ‘module’, ‘member’, ‘block’ and the like includes a plurality of components.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added. When a component, device, element, or the like of the present disclosure is described as having a purpose or performing an operation, function, or the like, the component, device, or element should be considered herein as being “configured to” meet that purpose or to perform that operation or function.

Throughout the specification, when a member is located “on” another member, this includes not only when one member is in contact with another member but also when another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, embodiments of the disclosure are described in detail with reference to the accompanying drawings.

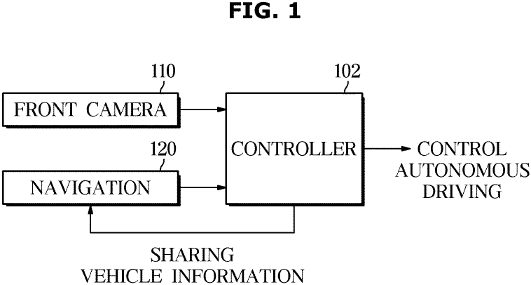

FIG. 1 is a view showing a control system of a vehicle according to an embodiment of the present disclosure.

As shown in FIG. 1, a front camera 110 and a navigation 120 are connected to an input side of a controller 102 so as to be communicable. The controller 102 may be an Electronic Control Unit (ECU) provided to control overall autonomous driving of a vehicle.

The front camera 110 is provided to capture a foreground of the vehicle. In one form, the front camera 110 may be installed near a rearview mirror inside the vehicle or inside a grill of an exterior of the vehicle. The image of the foreground captured by the front camera 110 is transmitted to the controller 102. The controller 102 analyzes the image of the foreground captured using the front camera 110 to obtain information on a road on which the vehicle is driving. Road information may include a total number of lanes on a road and which lane on which the vehicle is currently driving. For example, if the vehicle is driving on a second lane on a three-lane one way road, the total number of lanes is 3, and the driving lane is 2, that is, second lane.

The navigation (or a navigation device) 120 is provided to perform route guidance to a driver. In other words, when the driver selects a destination, the navigation system searches for a route from a current location of the vehicle to a destination and displays the searched route through a display linked to the navigation 120. If a waypoint other than the destination is further selected, a route for reaching the destination via the set waypoint may be searched and guided.

The controller 102 may obtain road information by analyzing an image captured by the front camera 110, and share the obtained road information with the navigation 120, so that the obtained road information may be reflected in a map display of the navigation 120. Herein, the road information may include information on a total number of lanes (e.g., three lanes) of the currently driving road and information on the current lane (e.g., the second lane) on which the vehicle is positioned. In other words, in addition to the map information secured in the navigation 120, the navigation 120 additionally reflects the total number of lanes obtained through analysis of the image captured by the front camera 110 and information on the current lane of the vehicle, leading to displaying a map for route guidance.

Furthermore, the controller 102 may utilize the road information to control autonomous driving of the vehicle. In other words, the controller 120 accurately acquires the total number of lanes on a road on which the vehicle is currently driving and information on the currently driving lane, and shares it with the navigation 120. Thus, the controller 120 can use it for autonomous driving control and may also perform a lane change quickly and accurately at a time when a lane change is required such that the vehicle can accurately follow a route from a current location of the vehicle to a destination.

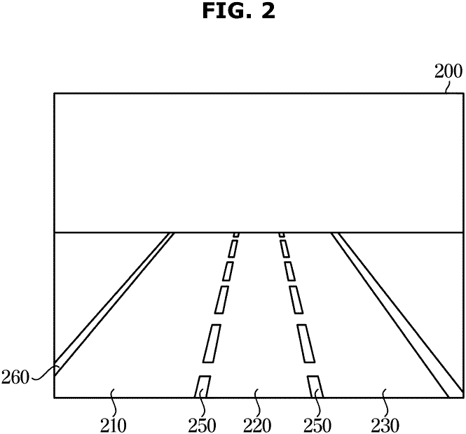

FIG. 2 is a view illustrating a foreground image of the vehicle captured using the front camera of the vehicle according to an embodiment of the present disclosure. In FIG. 2, a right-hand traffic road is illustrated as a reference.

If the foreground of the vehicle is captured using the front camera 110 installed to face a front side of the vehicle, an image 200 as shown in FIG. 2 may be obtained. As shown in FIG. 2, the road may include at least one lane. In FIG. 2, the road includes a total of three lanes 210, 220 and 230.

Each of the lanes 210, 220 and 230 may be divided by lines 250. The lines 250 for dividing the lanes 210, 220 and 230 are generally in the form of a white dotted line, but in a tunnel or a bridge, the lines 250 for dividing lanes 210, 220 and 230 may be in the form of a white solid line.

Each of the lanes 210, 220 and 230 may be referred to as a first lane 210, a second lane 220, and a third lane 230 in order from the lane 210 closest to a center line 260 to the farthest lane 230. If there are more lanes, they may be referred to as fourth lanes, fifth lanes... The center line is in the form of a solid yellow line. On some roads, a median may be installed instead of the solid yellow center line. Accordingly, based on the solid yellow line or the median, the first lane 210, the second lane 220, the third lane 230... may be distinguished.

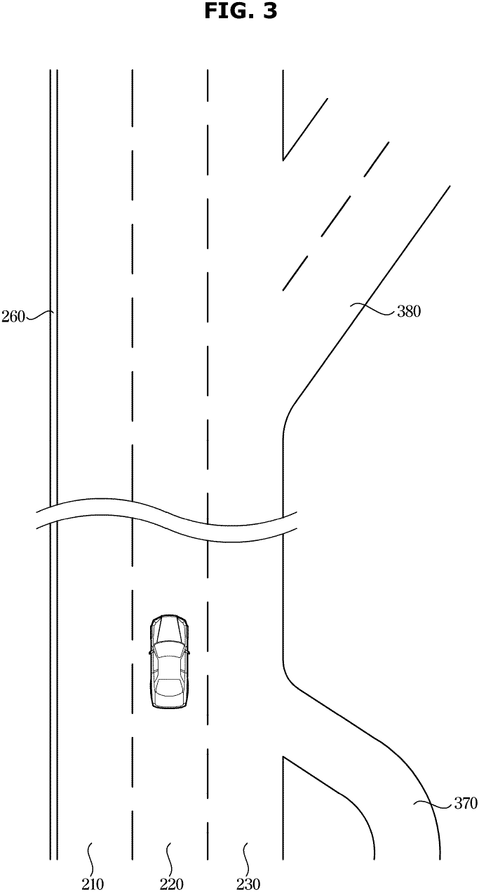

FIG. 3 is a view illustrating a shape of a road having an entrance (or referred to as an enter road) and an exit (or referred to as an exit road).

The road shown in FIG. 3 has the same structure as the road shown in FIG. 2 described above. In other words, the road shown in FIG. 3 is consisted of three lanes 210, 220 and 230 based on the leftmost center line 260.

An enter road 370 and an exit road 380 may be provided in the rightmost third lane 230. The enter road 370 consists of a single lane, and the exit road 380 consists of two lanes. If the vehicle enters the main road through the enter road 370, information on the road on which the vehicle travels is changed from a one-lane road to a three-lane road. Alternatively, if the vehicle proceeds through the exit road 380 while driving the main road, information on the road on which the vehicle travels is changed from a three-lane road to a two-lane road.

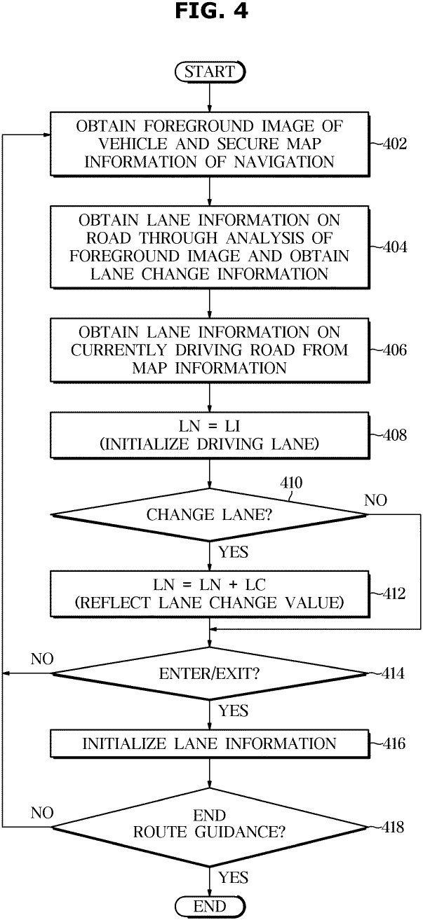

FIG. 4 is a view illustrating a method of controlling the vehicle according to an exemplary embodiment of the present disclosure.

As shown in FIG. 4, the controller 102 obtains the foreground image of the vehicle using the front camera 110 and also secures map information of the navigation 120 (402).

The controller 102 obtains lane information of the road on which the vehicle is currently driving through analysis of the foreground image captured by the front camera 110. The controller 102 also obtains lane change information when the vehicle changes lanes (404). The lane information on the road may include information on the total number of lanes on the road. The lane change information of the vehicle is information indicating how many lanes the vehicle has changed from the driving lane to which direction before the lane change. For example, if the driving lane is changed from lane 3 to lane 1, a lane change value is -2. For example, if the driving lane is changed from lane 3 to lane 5, the lane change value is +2. For example, when the driving lane is changed from lane 5 to lane 2, the lane change value is -3. For example, if the driving lane is changed from lane 1 to lane 5, the lane change value is +4. It is desirable to safely change lanes in stages, one lane at a time.

Furthermore, the controller 102 obtains the lane information on the currently driving road from the map information of the navigation 120 (406). The lane information that the controller 102 obtains from the map information of the navigation 120 may include the total number of lanes of the road on which the vehicle is currently driving and information on a straight lane, a right-turn lane, and a left-turn lane at an intersection.

The controller 102 performs initialization indicating which lane the vehicle is currently driving from which lane of the road to which lane of the road based on the lane information obtained through operations 402 to 406 of FIG. 4 (408). At this time, an initialization value of the driving lane is Ln = Li. If the vehicle enters third lane of a one-way 3-lane road, the driving lane has an initial value of Li = Ln = 3 because the driving lane is the third lane.

If the vehicle changes lanes while driving along the third lane (YES in 410), the controller 102 updates the driving lane value by reflecting the lane change value (412). At this time, an updated driving lane value is Ln = Ln + Lc. Lc is the lane change value (increased value or decreased value). If the vehicle changes lanes to the fifth lane while driving on the third lane, the current driving lane value is 3 (current Ln = 3) and the lane change value is +2 (Lc = +2), so that the updated current driving lane value Ln is 5 (updated Ln = 5). Alternatively, If the vehicle changes lanes to the first lane while driving on the fifth lane, the current driving lane value is 5 (current Ln = 5) and the lane change value is -4 (Lc = -4), so that the updated current driving lane value Ln is 1 (updated Ln = 1).

By sharing the updated driving lane information with the navigation 120, the controller 102 guides the route by reflecting the updated driving lane information in addition to the map information of the navigation 120. Accordingly, the controller 102 may provide more accurate driving lane information compared to a route guidance performed solely by the navigation 120. Furthermore, the controller 102 reflects the updated driving lane information in the autonomous driving of the vehicle, so that the autonomous driving of the vehicle may be performed more precisely and safely.

In operation 410, if the lane change is not performed (“No” in operation 410), the controller 102 omits the update of the driving lane information reflecting the lane change value (412), and proceeds to operation 414 described below.

The controller 102 identifies whether the vehicle enters or exits another road out of the currently driving road (414).

In response to that the vehicle travels on the current road as it is (“No” in operation 414), the controller 102 proceeds to operation 402 described above, and repeats operations 402 to 414 for the current road.

Conversely, in response to that the vehicle leaves the current road and enters or exits another road, the controller 102 initializes the currently updated lane information (416). In other words, the information on the road before entering or exiting is initialized.

In response to that the vehicle continues to guide the route through the navigation 120 after entering or exiting a new road (“No” in operation 418), the controller 102 repeats operations 402 to 416 for the new road due to entering or exiting.

As is apparent from the above, in various embodiments of the present disclosure, by accurately acquiring information on the lane of the road on which the vehicle is driving and reflecting the information on the map data of the navigation system, accurate road information may be guided in the navigation system.

On the other hand, the above-described embodiments may be implemented in the form of a recording medium storing instructions executable by a computer. The instructions may be stored in the form of program code. When the instructions are executed by a processor, a program module is generated by the instructions so that the operations of the disclosed embodiments may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although embodiments of the disclosure have been shown and described, it would be appreciated by those having ordinary skill in the art that changes may be made in these embodiments without departing from the principles and spirit of the disclosure, the scope of which is defined in the claims and their equivalents.

What is claimed is:

1. A method of controlling a vehicle, comprising:
obtaining information on a first lane of a currently driving road from a foreground image of the vehicle;
obtaining information on a second lane of the currently driving road from map data of a navigation; and
updating the information on the second lane of the map data by sharing the information on the first lane obtained from the foreground image of the vehicle with the navigation.

2. The method of claim 1, wherein
the information on the first lane includes a total number of lanes on the currently driving road, information on a lane on which the vehicle is driving, and lane change information of the vehicle.

3. The method of claim 1, wherein
the information on the second lane includes a total number of lanes on the currently driving road and information on a lane on which the vehicle is driving.

4. The method of claim 1, wherein updating the information on the second lane further comprises:
reflecting driving lane change information of the information on the first lane in addition to a total number of lanes on the currently driving road and information on the lane on which the vehicle is driving.

5. The method of claim 1, further comprising:
in response to that the vehicle enters or exits a new road from the currently driving road,
initializing the information on the first lane and the information on the second lane based on road information of the new road.

6. A vehicle, comprising:
a camera configured to photograph a foreground image of the vehicle;
a navigation configured to guide a route to a destination; and
a controller configured to:
obtain information on a first lane of a currently driving road from the foreground image of the vehicle photographed by the camera,
obtain information on a second lane of the currently driving road from map data of the navigation, and
update the information on the second lane of the map data by sharing the information on the first lane obtained from the foreground image of the vehicle with the navigation.

7. The vehicle of claim 6, wherein
the information on the first lane includes a total number of lanes on the currently driving road, information on a lane on which the vehicle is driving, and lane change information of the vehicle.

8. The vehicle of claim 6, wherein
the information on the second lane includes a total number of lanes on the currently driving road and information on a lane on which the vehicle is driving.

9. The vehicle of claim 6, wherein
the information on the second lane is updated further based on driving lane change information of the information on the first lane in addition to a total number of lanes on the currently driving road and information on the lane on which the vehicle is driving.

10. The vehicle of claim 6, wherein the controller is further configured to:
initialize the information on the first lane and the information on the second lane based on road information of a new road in response to that the vehicle enters or exits the new road from the currently driving road.

11. A method of controlling a vehicle, comprising:
obtaining, by a controller, from a foreground image of the vehicle, information on a first lane including: a total number of lanes on a currently driving road, information on a lane on which the vehicle is driving, and lane change information of the vehicle;
obtaining, by the controller, information on a second lane including the total number of lanes on the currently driving road and information on the lane on which the vehicle is driving from map data of a navigation;
updating, by the controller, the information on the second lane of the map data by sharing the information on the first lane obtained from the foreground image of the vehicle with the navigation; and
initializing, by the controller, the information on the first lane and the information on the second lane based on road information of a new road in response to that the vehicle enters or exits the new road from the currently driving road.

12. The method of claim 11, wherein updating the information on the second lane further comprises:
reflecting driving lane change information of the information on the first lane in addition to a total number of lanes on the currently driving road and information on the lane on which the vehicle is driving.

13. A vehicle, comprising:
a camera configured to capture a foreground image of the vehicle;
a navigation configured to guide a route to a destination; and
a controller configured to:
obtain information on a first lane including: a total number of lanes on a currently driving road, information on a lane on which the vehicle is driving, and lane change information of the vehicle, from the foreground image of the vehicle captured by the camera;
obtain information on a second lane including the total number of lanes on the currently driving road and information on the lane on which the vehicle is driving from map data of the navigation;
update the information on the second lane of the map data by sharing the information on the first lane obtained from the foreground image of the vehicle with the navigation; and
initialize the information on the first lane and the information on the second lane based on road information of a new road in response to that the vehicle enters or exits the new road from the currently driving road.

14. The vehicle of claim 13, wherein
the information on the second lane is updated further based on driving lane change information of the information on the first lane in addition to a total number of lanes on the currently driving road and information on the lane on which the vehicle is driving.
